(19) United States
(12) Patent Application Publication
(10) Pub. No.: US 2006/0103097 A1
(43) Pub. Date: May 18, 2006

(54) Folding structure for a scooter

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/989,302

(22) Filed: Nov. 17, 2004

(51) Int. Cl. B62M 1/00

(52) U.S. Cl. 280/87.05

(57) ABSTRACT

A folding structure for a scooter includes a frame, a roller, a handle frame, a linking block, a quick release set and a cover. The linking block is pivotally connected to slots of the handle frame with the quick release set. Connecting sections of the frame and the handle frame are pivotally connected with each other. The roller is pivotally connected within the connection section of the frame to seal an open space of the connecting section of the frame. The cover is secured to seal an open space of the connecting section of the handle frame.

### BACKGROUND OF THE INVENTION

1. Field of the Invention

This invention relates to a scooter folding structure, and more particularly to a folding structure securely covered to protect an operator from getting hurt when operating the scooter.

2. Description of the Related Art

As shown in FIG. 8, a conventional folding structure for a scooter comprises a frame A and a handle frame B. The frame A comprises a connection section A2 having an opening A1. The handle frame B comprises a connecting section B2 having an opening B1. The two connecting sections A2 and B2 are pivotally connected together with a quick release set C. Both the connection sections A2 and B2 are in an open status, so when users operate the folding structure, they often get their fingers pinched.

### SUMMARY OF THE INVENTION

It is the primary objective of the present invention to provide a folding structure for a scooter, which comprises a roller secured to an open space of a connecting section of a frame to protect users' fingers from being pinched.

It is another objective of the present invention to provide the folding structure for a scooter, which comprises a cover secured to an open space of a connecting section of a handle frame to protect users' fingers from being pinched.

It is a further objective of the present invention to provide the folding structure for a scooter, which is easy to operate.

### BRIEF DESCRIPTION OF THE DRAWINGS

FIG. 1 is a side view of the present invention;

FIG. 2 is an exploded view of the present invention;

FIG. 3 is an enlarged perspective view of the present invention;

FIG. 4 is a side cross-sectional view showing that a shaft of a quick release set is engaged in first troughs;

FIG. 5 is a view similar to FIG. 4 showing that a linking block is pushed upwardly to link the shaft to detached from the first troughs;

FIG. 6 is a side cross-sectional view showing that the shaft is engaged in second troughs;

FIG. 7 is an enlarged perspective view of the present invention in a collapsed status, and

FIG. 8 is a perspective view of a prior art.

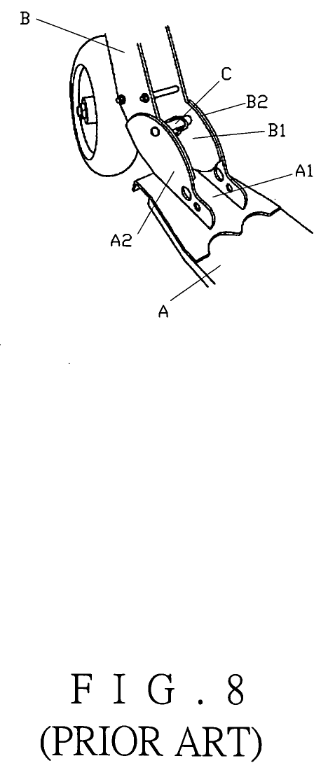

### DETAILED DESCRPTION OF THE PREFERRED EMBODIMENT

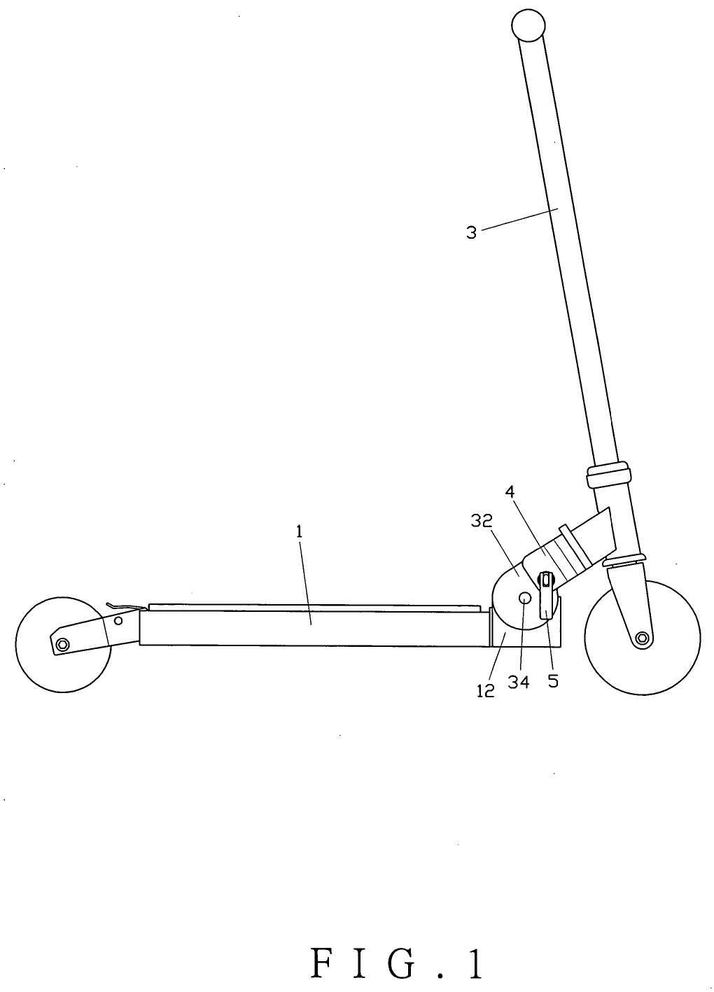

As shown in FIGS. 1, 2 and 3, the present invention comprises a frame 1, a roller 2, a handle frame 3, a linking block 4, a quick release set 5 and a cover 6.

The frame 1 has a connection section 12 at the front end. The connection section 12 comprises an open space 11, a pair of pivoting holes 13, a pair of first troughs 14 and a pair of second troughs 15 on the edge of the connecting section 12.

The roller 2 is pivotally connected within the connecting section 12 of the frame 1 to seal the open space 11 of the connecting section 12 of the frame 1. The roller 2 comprises a curved wall 21 having an opening 22 at one end of the wall 21. A hole 23 is formed in the center of the roller 2 and an open hole 24 is interconnected with the hole 23.

The handle frame 3 is pivotally connected with the connecting section 12 of the frame 1 and comprises a connecting section 32 having an open space 31. The connecting section 32 has a pair of pivoting holes 33 for a shaft 34 to insert there through, and a pair of slots 35 close to the pivoting holes 33.

The linking block 4 is a reverse U-shaped member and is adapted to secure the connecting section 32 of the handle frame 3 and to cover the slots 35. The linking block 4 is provided with a pair of holes 41.

The quick release set 5 has a shaft 51 which is inserted through the holes 41 of the linking block 4 and the slots 35 of the handle frame 3. The shaft 51 comprises a sleeve 511 adapted to receive one end 53 of a spring 52. The spring 52 has another end 54 secured to the shaft 34 of the handle frame 3. The shaft 51 is secured with a nut 55 at the opposite end.

The cover 6 is secured on the open space 31 of the handle frame 3 to seal the open space 31.

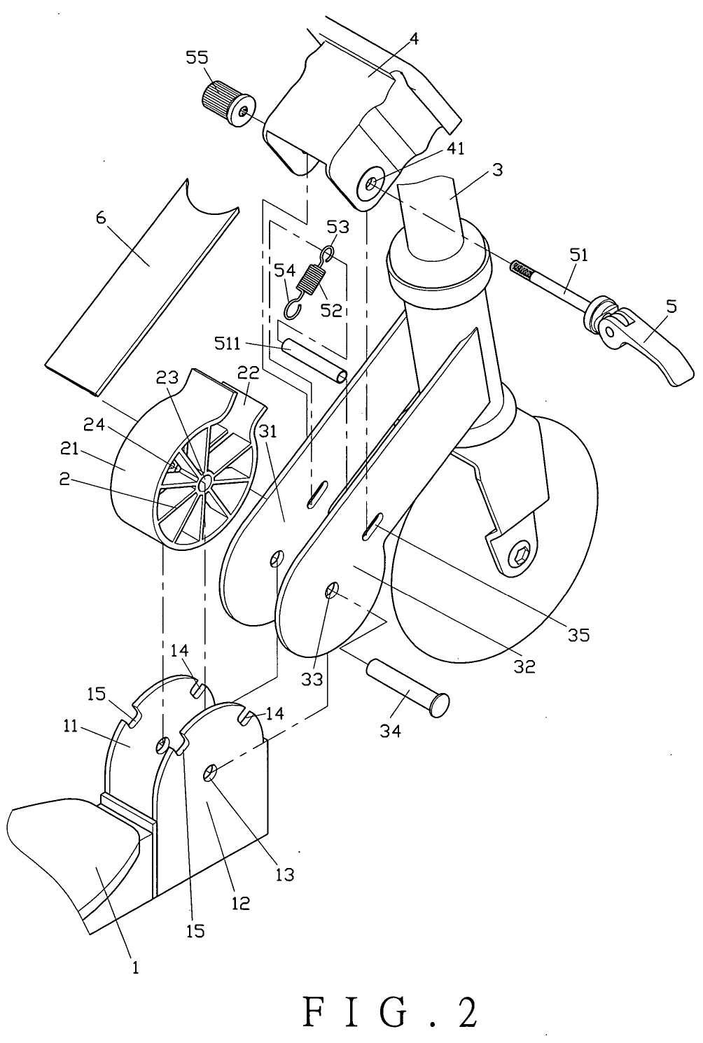

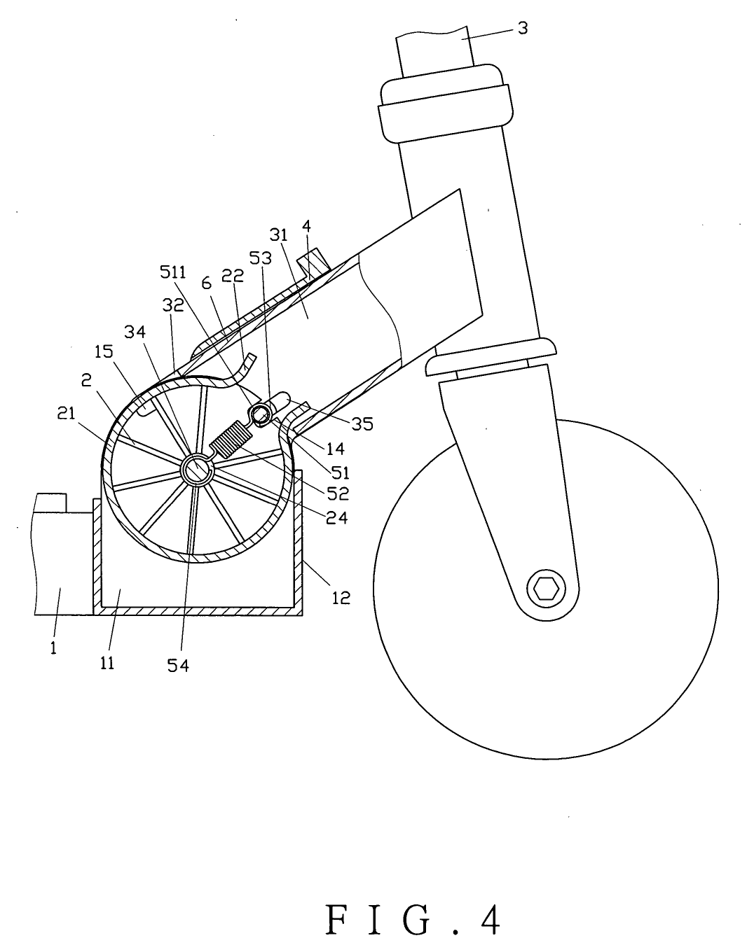

To assemble the present invention, as shown in FIGS. 2, 3, and 4, the roller 2 is placed into the open space 11 of the connecting section 12 of the frame 1. The connecting section 32 of the handle frame 3 overlaps the connecting section 12 of the frame 1 to align the pivoting holes 33 and 13 together. The end 54 of the spring 52 is inserted through the open hole 24 into the hole 23 of the roller 2. The shaft 34 is inserted through the pivoting holes 33 of the handle frame 3, the pivoting holes 13 of the frame 1 and the hole 23 of the roller 2 with the end 54 of the spring 52 hooked thereto. The linking block 4 is covered onto the connecting section 32 of the handle frame 3 with the holes 41 of the linking block 4 aligning with the slots 35 of the connecting section 32 of the handle frame 3. The shaft 51 of the quick release set 5 with the sleeve 511 is inserted through the holes 41 of the linking block 4 and the slots 35 of the handle frame 3, and secured by the nut 55 from the other end thereof. The other end 53 of the spring 52 is secured to the sleeve 511 of the shaft 51 of the quick release set 5. The pulling force from the spring 52 urges the shaft 51 to engage in the first troughs 14 of the connecting section 12 of the frame 1, and the handle frame 3 and the frame 1 are in an open status. The last step of assembly is to secure the cover 6 to the open space 31 of the handle frame 3. Thus the assembly of the present invention is completed.

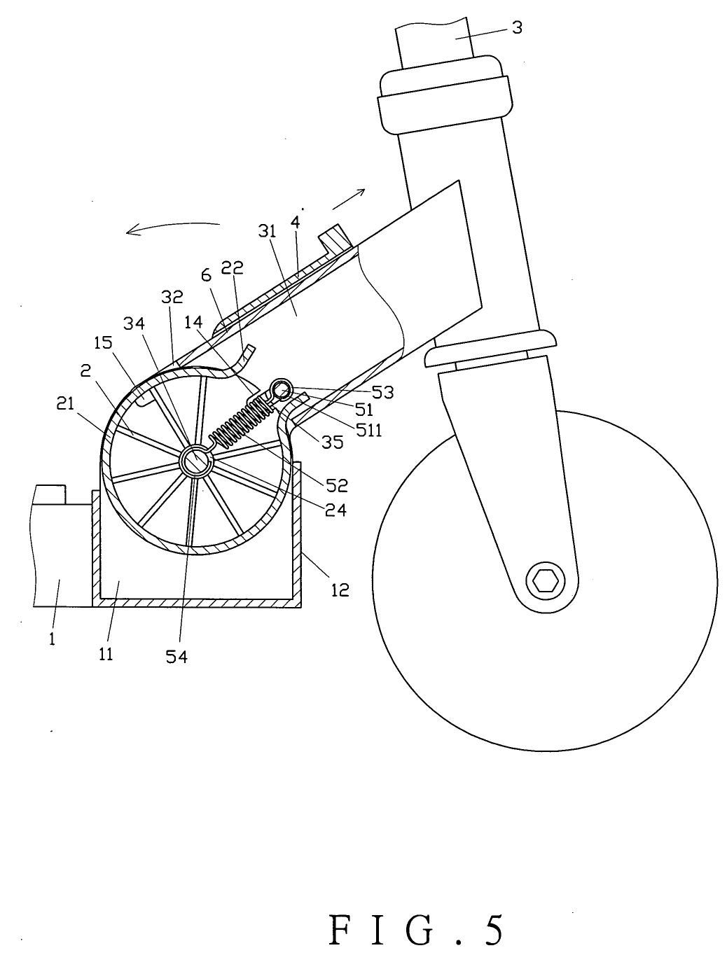

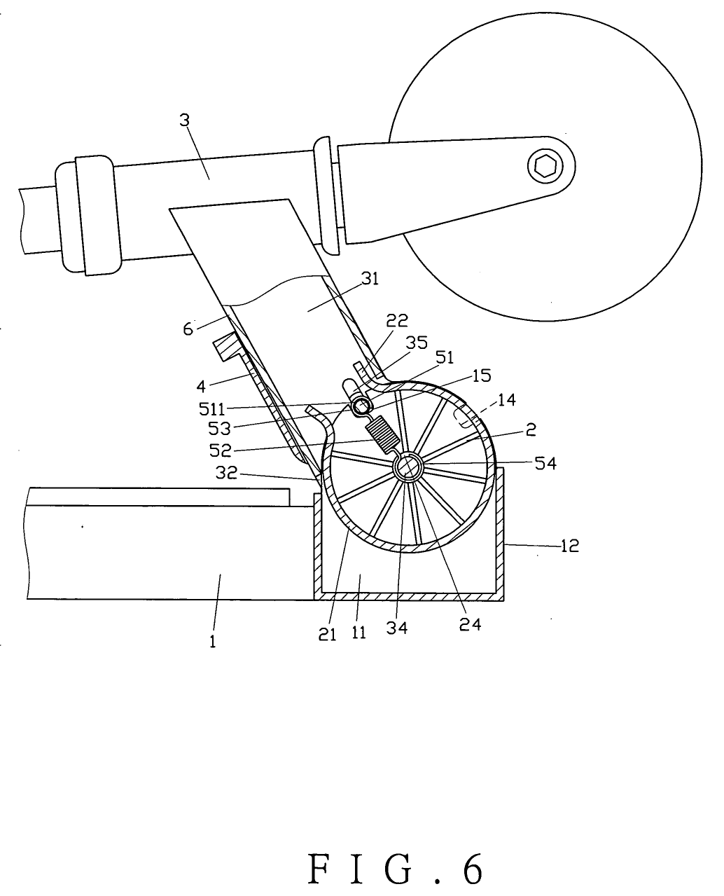

To collapse the handle frame 3, as shown in FIG. 5, the quick release set 5 is loosened, and the linking block 4 is pushed upwardly to link the shaft 51 of the quick release set 5 to slide along the slots 35, thus the shaft 51 is released from the first troughs 14, while the handle frame 3 is free to collapse towards the frame 1, and the shaft 51 is able to roll along the edge of the connecting section 12 of the frame 1 until it reaches to the second troughs 15. The shaft 51 will be urged by the spring 52 and the handle frame 3 is at a secure collapsing position, as shown in FIG. 6.

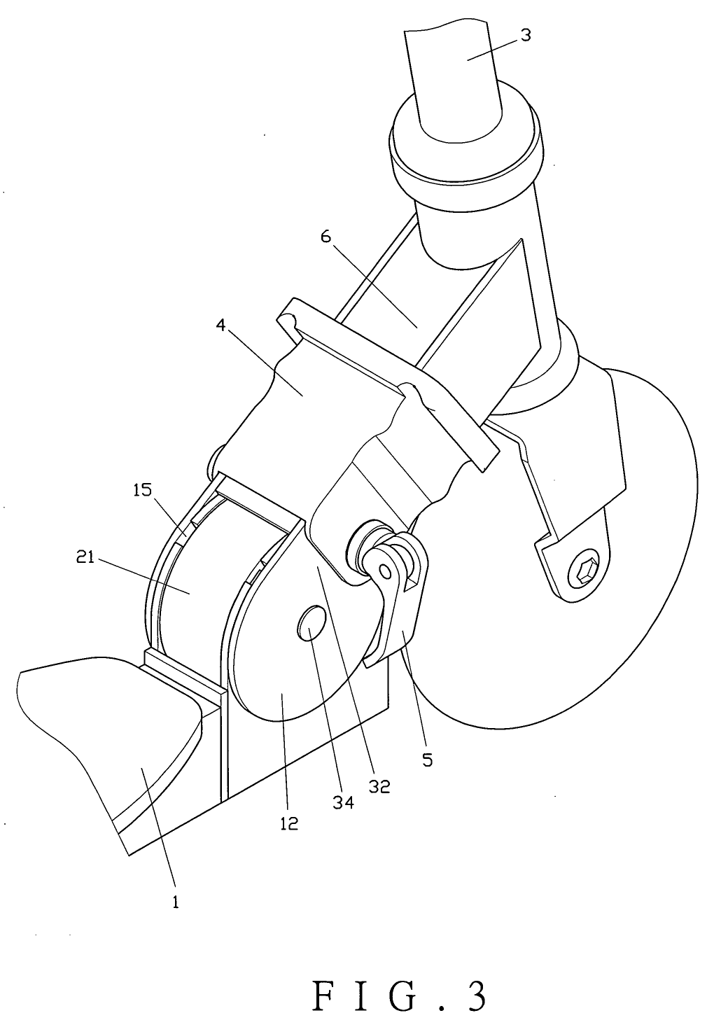

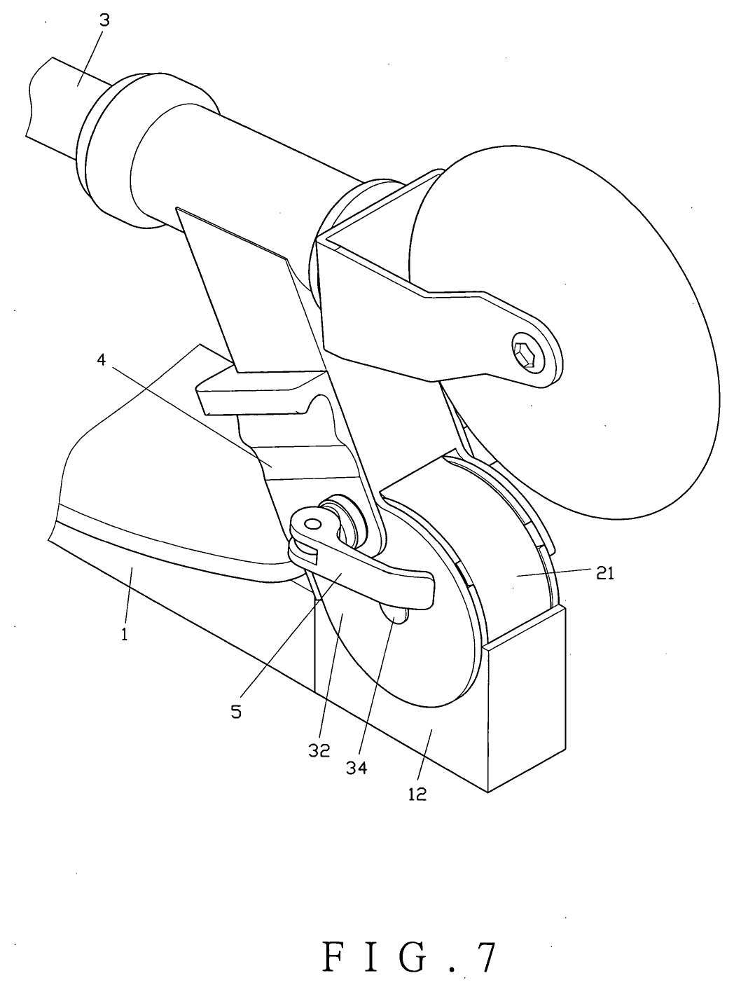

Because the wall 21 of the roller 2 seals off the open space 11 of the connecting section 12 of the frame 1, as shown in FIGS. 3 and 7, and the cover 6 seals the open space 31 of the handle frame 3, thus the operation of folding or unfolding the scooter is safe.

I claim:

1. A folding structure for a scooter comprising:
a frame comprising a connecting section having an open space, said connecting section comprising first troughs and second troughs;
a handle frame pivotally connected with said connecting section of said frame comprising a connecting section having an open space, said connecting section of said handle frame further comprising a shaft and a pair of slots;
a quick release set inserted into said slots of said handle frame comprising a shaft to hook one end of a spring, said spring having another end secured to said shaft of said handle frame;
a roller pivotally connected within said connecting section of said frame to seal said open space of said connecting section of said frame, said roller comprising a curved wall with an opening at one end thereof;
a linking block pivotally connected to said handle frame outwardly with said shaft of said quick release set sliding along said slots of said handle frame;
a cover being secured onto said open space of said handle frame.

2. The folding structure for a scooter, as recited in claim 1, wherein said connecting section of said frame and said connecting section of said handle frame comprise pivoting holes, respectively, for insertion of said shaft of said frame handle.

3. The folding structure for a scooter, as recited in claim 1, wherein said linking block is a reverse U-shaped member and comprises a pair of holes for insertion of said shaft of said quick release set.

4. The folding structure for a scooter, as recited in claim 1, wherein said roller comprises a hole at the center and an open hole interconnected with said hole.
